(19) United States
(12) Patent Application Publication
(10) Pub. No.: US 2023/0001918 A1
(43) Pub. Date: Jan. 5, 2023

(54) VEHICLE CONTROL SYSTEM

(71) Applicant: SUBARU CORPORATION, Tokyo (JP)

(72) Inventors: Daiki KOIKE, Tokyo (JP); Masatoshi MINAKAWA, Tokyo (JP); Toshihiro HAYASHI, Tokyo (JP); Yuya INNAMI, Tokyo (JP); Ryo FUKUHARA, Tokyo (JP)

(21) Appl. No.: 17/849,102

(22) Filed: Jun. 24, 2022

(30) Foreign Application Priority Data
Jul. 5, 2021 (JP) 2021-111591

(51) Int. Cl. B60W 30/09; B60W 30/095; B60W 30/18; B60W 40/04

(52) U.S. Cl. CPC B60W 30/09; B60W 30/0956; B60W 30/18154; B60W 40/04; B60W 2554/4023; B60W 2556/40

(57) ABSTRACT

A vehicle control system includes a vehicle estimator and a stop position setter. The vehicle estimator is configured to make determination on whether an entering vehicle entering an oncoming lane from an intersecting road is present, and estimate an overall length of the entering vehicle upon determining that the entering vehicle is present. The intersecting road intersects a traveling road where a vehicle to which the vehicle control system is applied is traveling. The stop position setter is configured to set a stop position of the vehicle based on the determination made by the vehicle estimator as to whether the entering vehicle is present and the estimated overall length of the entering vehicle.

### CROSS-REFERENCE TO RELATED APPLICATIONS

The present application claims priority from Japanese Patent Application No. 2021-111591 filed on Jul. 5, 2021, the entire contents of which are hereby incorporated by reference.

### BACKGROUND

The disclosure relates to a vehicle control system that changes, when approaching an intersection, a stop position by recognizing a situation of an intersecting road and the type of a vehicle entering the intersection from the intersecting road.

There is known a driving operation assistance device that notifies a driver about approach of his/her vehicle to a temporary stop point on a road based on temporary stop point data stored in a map database of a car navigation system to prevent inexecution of the driver's temporary stop at the temporary stop point.

Japanese Unexamined Patent Application Publication (JP-A) No. 2013-190963 discloses a distribution system that distributes, to a vehicle traveling along a non-priority road, a target stop position set based on a road type and a driving tendency of a driver when the vehicle enters an intersection where a temporary stop is expected and no traffic light is provided.

### SUMMARY

An aspect of the disclosure provides a vehicle control system including a vehicle estimator and a stop position setter. The vehicle estimator is configured to make determination on whether an entering vehicle entering an oncoming lane from an intersecting road is present, and estimate an overall length of the entering vehicle upon determining that the entering vehicle is present. The intersecting road intersects a traveling road where a vehicle to which the vehicle control system is applied is traveling. The stop position setter is configured to set a stop position of the vehicle based on the determination made by the vehicle estimator as to whether the entering vehicle is present and the estimated overall length of the entering vehicle.

An aspect of the disclosure provides a vehicle control system including circuitry. The circuitry is configured to make determination on whether an entering vehicle entering an oncoming lane from an intersecting road is present, and estimate an overall length of the entering vehicle upon determining that the entering vehicle is present. The intersecting road intersects a traveling road where a vehicle to which the vehicle control system is applied is traveling. The circuitry is configured to set a stop position of the vehicle based on the determination as to whether the entering vehicle is present and the estimated overall length of the entering vehicle.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to describe the principles of the disclosure.

FIG. 1 illustrate the configuration of a vehicle control system according to an embodiment of the disclosure;

FIG. 2 illustrates a situation of an intersection when setting a stop position; and

FIG. 3 is a flowchart illustrating an example of a flow of a stop position setting process.

### DETAILED DESCRIPTION

In the technology described in JP-A No. 2013-190963, for example, when a large-sized vehicle traveling along a priority road intersecting a non-priority road where a target vehicle is traveling enters the non-priority road from the priority road, there is a possibility that the traveling of the large-sized vehicle is hindered depending on the stop position of the target vehicle.

In the technology described in JP-A No. 2013-190963, the target stop position is set based on the road type and the driving tendency of the driver. Therefore, even in a case where a large-sized vehicle traveling along the priority road does not enter the non-priority road where the target vehicle is traveling and therefore the traveling of the large-sized vehicle is not hindered, there is a possibility that the target vehicle stops at a point with a distance behind the stop line and the driver has discomfort.

It is desirable to provide a vehicle control system that can appropriately set a stop position when a target vehicle approaches an intersection.

An embodiment of the disclosure is described with reference to the drawings.

In the drawings for use in the following description, individual constituent elements are scaled differently so that the constituent elements can be recognized in the drawings. The embodiment of the disclosure is not limited to the numbers, shapes, size ratios, and positional relationships of the constituent elements in the drawings.

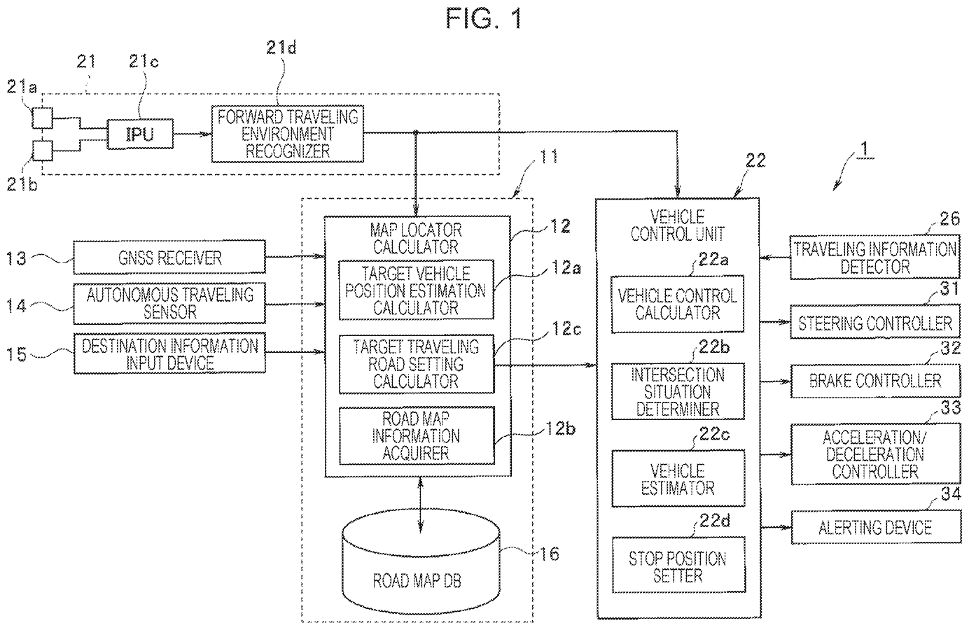

First, the overall configuration of a vehicle control system according to the embodiment of the disclosure is described with reference to FIG. 1.

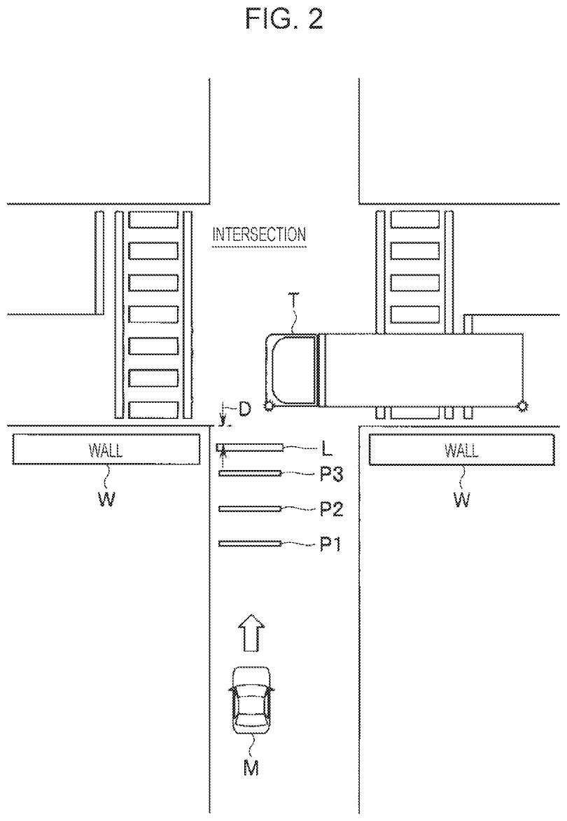

A vehicle control system 1 illustrated in FIG. 1 is mounted on a target vehicle M (see FIG. 2). The vehicle control system 1 includes a locator unit 11 that detects the position of the target vehicle M (target vehicle position), a camera unit 21 that acquires forward traveling environment information, and a vehicle control unit 22 that controls the vehicle. Throughout the present specification and the drawings, elements having substantially the same function and configuration are denoted with the same numerals to avoid any redundant description.

The locator unit 11 estimates a target vehicle position on a road map, and acquires road map data around the target vehicle position. The camera unit 21 acquires traveling environment information ahead of the target vehicle M, and recognizes, for example, right and left lane lines of a traveling lane, a road shape, the presence or absence of a preceding vehicle, and a traffic light. For example, the camera unit 21 obtains a road curvature at the center between the lane lines, a distance from the preceding vehicle, and a relative speed to the preceding vehicle.

The locator unit 11 includes a map locator calculator 12 and a high-accuracy road map database (in FIG. 1, abbreviated as “road map DB”) 16 serving as a storage. The map locator calculator 12, a forward traveling environment recognizer 21d described later, and the vehicle control unit 22 are each implemented by a known microcomputer including a CPU, a RAM, and a ROM and peripheral devices around the microcomputer. The ROM prestores programs to be executed by the CPU and fixed data such as base maps.

A global navigation satellite system (GNSS) receiver 13, an autonomous traveling sensor 14, and a destination information input device 15 are coupled to an input side of the map locator calculator 12. The GNSS receiver 13 receives positioning signals from a plurality of positioning satellites. The autonomous traveling sensor 14 enables autonomous traveling in an environment in which positioning signals cannot effectively be received due to low reception sensibility from GNSS satellites as in a case where the vehicle is traveling in a tunnel. The autonomous traveling sensor 14 includes a vehicle speed sensor, a gyro sensor, and a longitudinal acceleration sensor. The map locator calculator 12 obtains a moving distance and an azimuth based on, for example, a speed of the target vehicle M (target vehicle speed) detected by the vehicle speed sensor, an angular velocity detected by the gyro sensor, and a longitudinal acceleration detected by the longitudinal acceleration sensor, and performs localization based on the obtained moving distance and the obtained azimuth.

For example, the destination information input device 15 is a terminal device to be operated by a person in the vehicle, such as a driver or any other occupant. The destination information input device 15 can collectively input a sequence of information pieces to be used for setting a traveling route in the map locator calculator 12, such as settings of either one of a destination and a stopover (for example, a service area on an expressway).

Examples of the destination information input device 15 include an inputter of a car navigation system (for example, a touch panel of a monitor), a mobile terminal such as a smartphone, and a personal computer. The destination information input device 15 is coupled to the map locator calculator 12 by wire or wireless.

When the driver or any other occupant inputs information on either one of the destination and the stopover (for example, the name of a facility, an address, and a phone number) by operating the destination information input device 15, the input information is read by the map locator calculator 12. The map locator calculator 12 sets position coordinates (latitude and longitude) of either one of the destination and the stopover thus input.

The map locator calculator 12 includes a target vehicle position estimation calculator 12a that estimates a target vehicle position, a road map information acquirer 12b, and a target traveling road setting calculator 12c that sets a target traveling road. The target vehicle position estimation calculator 12a acquires position coordinates (latitude and longitude) serving as positional information of the target vehicle M based on positioning signals received by the GNSS receiver 13. In an environment in which effective positioning signals cannot be received from the positioning satellites due to low sensibility of the GNSS receiver 13, the target vehicle position estimation calculator 12a estimates the position coordinates of the target vehicle M based on a signal from the autonomous traveling sensor 14.

The road map information acquirer 12b matches the position coordinates of the target vehicle M and the position coordinates (latitude and longitude) of the destination set by the destination information input device 15 on a road map stored in the high-accuracy road map database 16. The road map information acquirer 12b determines both the positions and transmits, to the target traveling road setting calculator 12c, road map information around an area from the current target vehicle position to the destination.

The high-accuracy road map database 16 is a large-capacity storage medium such as an HDD, and stores high-accuracy road map information (dynamic map). The high-accuracy road map information includes lane data for use in autonomous driving (for example, lane width data, lane center position coordinate data, lane azimuth angle data, and speed limits). The stored lane data includes pieces of data for several-meter intervals in each lane on the road map.

The target traveling road setting calculator 12c creates, on the road map, a traveling route coupling the current position and the destination matched by the road map information acquirer 12b. The target traveling road setting calculator 12c sequentially sets and updates, on the traveling route, target traveling roads where the target vehicle M is expected to travel autonomously (for example, straightforward traveling, right or left turn at intersections, right, left, and center traveling lanes in a case of a straightforward road, and lateral positions in the lanes) for several hundred meters to several kilometers ahead of the target vehicle M. The information on the target traveling roads is read by the vehicle control unit 22.

The camera unit 21 is fixed to an upper central part of a front area in a cabin of the target vehicle M, and includes an on-board camera (stereo camera), an image processing unit (IPU) 21c, and a forward traveling environment recognizer 21d. The on-board camera includes a main camera 21a and a subcamera 21b bilaterally symmetrical across the center in a vehicle width direction.

The main camera 21a and the subcamera 21b image a predetermined imaging area ahead of the target vehicle M, and output obtained traveling environment image information to the IPU 21c. The IPU 21c performs predetermined image processing for the input traveling environment image information, and outputs the resultant traveling environment image information to the forward traveling environment recognizer 21d.

The forward traveling environment recognizer 21d reads the traveling environment image information subjected to the image processing by the IPU 21c, and recognizes a forward traveling environment (forward traveling environment information) based on the traveling environment image information. The recognized forward traveling environment includes the shape of a traveling road where the target vehicle M is traveling (target vehicle traveling road) (a road curvature [1/m] at the center between right and left lane lines and a width between the right and left lane lines (lane width)), an intersection, a stop line L (see FIG. 2), the color of a traffic light, a road sign, and a person crossing the road, such as a pedestrian or a bicycle.

The vehicle control unit 22 includes a vehicle control calculator 22a, an intersection situation determiner 22b, a vehicle estimator 22c, and a stop position setter 22d. For example, the target traveling road setting calculator 12c of the map locator calculator 12, the forward traveling environment recognizer 21d of the camera unit 21, and a traveling information detector 26 that detects traveling information are coupled to an input side of the vehicle control unit 22. The vehicle control unit 22 acquires a traveling environment in a predetermined range of the target traveling road ahead of the target vehicle M based on the road map information around the target traveling road set by the target traveling road setting calculator 12c and the forward traveling environment information recognized by the forward traveling environment recognizer 21d.

The traveling information detector 26 is a generic term of various sensors that detect traveling information of the target vehicle M for use in the autonomous driving, such as a vehicle speed of the target vehicle M (target vehicle speed), acceleration and deceleration, a period to reach a stop line, and a distance and a relative vehicle speed between a preceding vehicle and the target vehicle M.

A steering controller 31, a brake controller 32, an acceleration/deceleration controller 33, and an alerting device 34 are coupled to an output side of the vehicle control unit 22. The steering controller 31 causes the target vehicle M to travel along a target traveling road. The brake controller 32 decelerates or stops the target vehicle M by forcible braking. The acceleration/deceleration controller 33 controls the vehicle speed of the target vehicle M. The alerting device 34 alerts the driver depending on a situation recognized based on a forward traveling environment.

The vehicle control calculator 22a performs predetermined control on the steering controller 31, the brake controller 32, and the acceleration/deceleration controller 33 to cause the target vehicle M to autonomously travel along the target traveling road on the road map that is set by the target traveling road setting calculator 12c based on the positioning signals received by the GNSS receiver 13 and indicating the target vehicle position. At this time, the vehicle control calculator 22a performs known adaptive cruise control (ACC) and active lane keep (ALK) control based on the forward traveling environment recognized by the forward traveling environment recognizer 21d so that, when a preceding vehicle is detected, the target vehicle M follows the preceding vehicle and, when no preceding vehicle is detected, the target vehicle M travels along the traveling lane at an ACC vehicle speed set by the driver within a range below an upper speed limit of the road.

The intersection situation determiner 22b makes determination about an intersection situation ahead of the target vehicle M based on the forward traveling environment information recognized by the forward traveling environment recognizer 21d. The intersection situation determiner 22b determines whether the target vehicle M is approaching the stop line L. When determination is made that the target vehicle M is approaching the stop line L, the intersection situation determiner 22b detects a distance D from the stop line L to an intersecting road (or intersection) based on the forward traveling environment recognized by the forward traveling environment recognizer 21d. The intersection situation determiner 22b determines whether the intersecting road that intersects the traveling road where the target vehicle M is traveling is either one of a national road and a prefectural road based on road information acquired by the road map information acquirer 12b from the high-accuracy road map database 16.

The vehicle estimator 22c makes determination about a vehicle entering an oncoming lane for the target vehicle M from the intersecting road based on the forward traveling environment information recognized by the forward traveling environment recognizer 21d. The vehicle estimator 22c determines whether a vehicle blinking a turn signal is present at the intersection ahead. When determination is made that the blinking vehicle is present, the vehicle estimator 22c makes determination about the speed of the blinking vehicle. The vehicle estimator 22c estimates the overall length of the blinking vehicle based on the forward traveling environment information recognized by the forward traveling environment recognizer 21d. For example, the vehicle estimator 22c estimates the overall length of the blinking vehicle based on the amount of projection of the blinking vehicle into the intersection. When there is no obstacle such as walls W, the vehicle estimator 22c may calculate the overall length of the blinking vehicle based on the forward traveling environment information recognized by the forward traveling environment recognizer 21d.

The stop position setter 22d sets a stop position of the target vehicle M based on the determination result from the intersection situation determiner 22b or based on the determination result from the intersection situation determiner 22b and the determination result from the vehicle estimator 22c. Based on the determination result from the intersection situation determiner 22b, the stop position setter 22d sets a stop at the stop line L when the distance D from the stop line L to the intersecting road is longer than a predetermined threshold, and sets a stop at any one of stop positions P1, P2, and P3 behind the stop line L instead of the stop at the stop line L when the distance D from the stop line L to the intersecting road is shorter than the predetermined threshold.

A large-sized vehicle such as a truck T has a large difference between paths of inner turning wheels and therefore turns right or left with a great radius at an intersection. When the target vehicle M stops at the stop line L while the large-sized vehicle such as the truck T (see FIG. 2) turns left from the intersecting road, the target vehicle M has a possibility of coming into contact or colliding with the large-sized vehicle turning with the great radius in a case where the distance D from the stop line L to the intersecting road is short. In a case where the distance D from the stop line L to the intersecting road is long, the target vehicle M does not come into contact or collide with the large-sized vehicle turning with the great radius. Thus, the stop position setter 22d sets a stop at the stop line L.

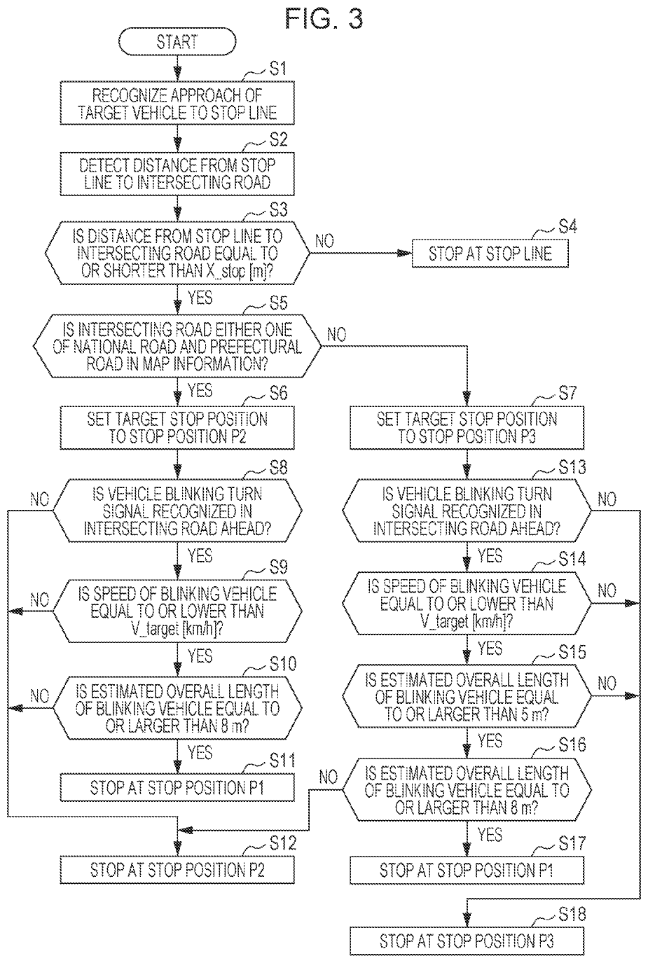

When determination is made not to stop at the stop line L, the stop position setter 22d sets a stop at any one of the stop positions P1, P2, and P3 based on the determination result from the intersection situation determiner 22b and the determination result from the vehicle estimator 22c. The stop positions to be set by the stop position setter 22d are not limited to the three stop positions P1, P2, and P3, and may be two stop positions or less or may be four stop positions or more. Determination as to which of the stop positions P1, P2, and P3 to set is described in detail with reference to a stop position setting process of FIG. 3.

When the entry of the large-sized vehicle into the oncoming lane is detected after the target vehicle M has stopped at any one of the stop positions P1, P2, and P3, the vehicle control unit 22 determines whether the target vehicle M at the stop position has a possibility of coming into contact or colliding with the large-sized vehicle turning with the great radius. When determination is made that the target vehicle M has the possibility of coming into contact or colliding with the large-sized vehicle, the vehicle control unit 22 controls the steering controller 31, the brake controller 32, and the acceleration/deceleration controller 33 to withdraw the target vehicle M from the stop position. At this time, the vehicle control unit 22 withdraws the target vehicle M from the stop position when no succeeding vehicle is present and the rear safety is confirmed based on information from, for example, a rear camera (not illustrated).

The stop position setting process is described with reference to FIG. 3. The stop position setting process of FIG. 3 is executed by the vehicle control unit 22 in every predetermined calculation period while the autonomous driving is being performed.

The vehicle control unit 22 recognizes that the target vehicle M is approaching a stop line L based on forward traveling environment information recognized by the forward traveling environment recognizer 21d of the camera unit 21 (Step S1). Then, the vehicle control unit 22 detects a distance D from the stop line L to an intersecting road (Step S2).

The vehicle control unit 22 determines whether the distance D from the stop line L to the intersecting road is equal to or shorter than X_stop [m] (Step S3). The value X_stop is a first threshold calculated based on the overall length of a general large-sized vehicle and a road shape such as a road width in a traveling lane that is acquired from either one of the camera unit 21 and the high-accuracy road map database.

When determination is made that the distance D from the stop line L to the intersecting road is not equal to or shorter than X_stop [m], the vehicle control unit 22 controls the steering controller 31, the brake controller 32, and the acceleration/deceleration controller 33 to cause the target vehicle M to stop at the stop line L (Step S4). That is, when the distance D from the stop line L to the intersecting road is longer than X_stop [m] that is the first threshold, the target vehicle M stops at the stop line L because there is a small possibility of either one of contact and collision even if the large-sized vehicle such as the truck T turns right or left with a great radius to enter the oncoming lane for the target vehicle M.

When determination is made that the distance D from the stop line L to the intersecting road is equal to or shorter than X_stop [m], the vehicle control unit 22 determines whether the intersecting road is either one of a national road and a prefectural road based on map information (Step S5). That is, the vehicle control unit 22 makes determination about the type of the intersecting road based on the map information. The vehicle control unit 22 may make determination about the type of the intersecting road by determination about, for example, the width and the amount of traffic of the intersecting road based on the forward traveling environment information recognized by the forward traveling environment recognizer 21d.

When determination is made that the intersecting road is either one of the national road and the prefectural road, the vehicle control unit 22 sets the target stop position to the stop position P2 (Step S6). When determination is made that the intersecting road is neither of the national road and the prefectural road, the vehicle control unit 22 sets the target stop position to the stop position P3 (Step S7).

In the case where the intersecting road is either one of the national road and the prefectural road, the road width is large and the number of traveling vehicles is also large. Therefore, the vehicle control unit 22 determines that there is a strong possibility that a large-sized vehicle turns right or left to enter the oncoming lane for the target vehicle M, and sets the target stop position to the stop position P2.

In the case where the intersecting road is neither of the national road and the prefectural road, the road width is small and the number of traveling vehicles is also small. Therefore, the vehicle control unit 22 determines that there is a small possibility that a large-sized vehicle turns right or left to enter the oncoming lane for the target vehicle M, and sets the target stop position to the stop position P3 closer to the stop line L than the stop position P2 is.

Description is made of a process after the target stop position has been set to the stop position P2 in Step S6. The vehicle control unit 22 determines whether a vehicle blinking a turn signal is recognized in the intersecting road ahead (Step S8).

When determination is made that no blinking vehicle is recognized in the intersecting road ahead, the vehicle control unit 22 causes the target vehicle M to stop at the stop position P2 (Step S12). When no blinking vehicle is recognized in the intersecting road ahead, the vehicle control unit 22 determines that there is a small possibility that a vehicle (in particular, a large-sized vehicle) turns right or left to enter the oncoming lane for the target vehicle M, and causes the target vehicle M to stop at the stop position P2 set as the target stop position in the process of Step S6.

When determination is made that the blinking vehicle is recognized in the intersecting road ahead, the vehicle control unit 22 determines whether the speed of the blinking vehicle is equal to or lower than V_target [km/h] (Step S9). The value V_target is a second threshold for determining whether the vehicle turns right or left to enter the oncoming lane for the target vehicle M. When the vehicle in the intersecting road turns right or left to enter the oncoming lane, the vehicle generally decelerates. Therefore, the second threshold is predetermined based on statistical data on the speed and deceleration during the right or left turn of the vehicle.

When determination is made that the speed of the blinking vehicle is not equal to or lower than V_target [km/h], the vehicle control unit 22 proceeds to Step S12 to cause the target vehicle M to stop at the stop position P2. When the blinking vehicle is recognized in the intersecting road and the speed of the blinking vehicle is higher than V_target [km/h] that is the second threshold, the vehicle control unit 22 determines that there is a small possibility that the blinking vehicle turns right or left to enter the oncoming lane for the target vehicle M, and causes the target vehicle M to stop at the stop position P2 set as the target stop position in the process of Step S6.

When determination is made that the speed of the blinking vehicle is equal to or lower than V_target [km/h], the vehicle control unit 22 determines whether the estimated overall length of the blinking vehicle is equal to or larger than 8 [m] (Step S10). By determining whether the estimated overall length of the blinking vehicle is equal to or larger than 8 [m] that is a third threshold, the vehicle control unit 22 presumes the vehicle entering the oncoming lane as either one of a large-sized vehicle and a vehicle other than the large-sized vehicle (for example, a small-sized vehicle or a medium-sized vehicle). Although the third threshold is 8 [m], any value other than 8 [m] may be used as long as determination can be made that the blinking vehicle is a large-sized vehicle. The vehicle control unit 22 may presume the vehicle entering the oncoming lane as either one of a large-sized vehicle and a vehicle other than the large-sized vehicle based on, for example, either one of the height of the turn signal and the width of the blinking vehicle.

When determination is made that the estimated overall length of the blinking vehicle is not equal to or larger than 8 [m], the vehicle control unit 22 proceeds to Step S12 to cause the target vehicle M to stop at the stop position P2. When the estimated overall length of the vehicle determined as entering the oncoming lane is smaller than 8 [m], the vehicle control unit 22 determines that there is a strong possibility that the vehicle entering the oncoming lane is not a large-sized vehicle, and causes the target vehicle M to stop at the stop position P2 set as the target stop position in the process of Step S6.

When determination is made that the estimated overall length of the blinking vehicle is equal to or larger than 8 [m], the vehicle control unit 22 causes the target vehicle M to stop at the stop position P1 (Step S11). When the estimated overall length of the blinking vehicle is equal to or larger than 8 [m], the vehicle control unit 22 determines that there is a strong possibility that the vehicle entering the oncoming lane is a large-sized vehicle, and causes the target vehicle M to stop at the stop position P1 farther away from the stop line L than the stop position P2 set as the target stop position in the process of Step S6.

Next, description is made of a process after the target stop position has been set to the stop position P3 in Step S7. The vehicle control unit 22 determines whether a vehicle blinking a turn signal is recognized in the intersecting road ahead (Step S13).

When determination is made that no blinking vehicle is recognized in the intersecting road ahead, the vehicle control unit 22 causes the target vehicle M to stop at the stop position P3 (Step S18). When no blinking vehicle is recognized in the intersecting road ahead, the vehicle control unit 22 determines that there is a small possibility that a vehicle (in particular, a large-sized vehicle) turns right or left to enter the oncoming lane for the target vehicle M, and causes the target vehicle M to stop at the stop position P3 set as the target stop position in the process of Step S7.

When determination is made that the blinking vehicle is recognized in the intersecting road ahead, the vehicle control unit 22 determines whether the speed of the blinking vehicle is equal to or lower than V_target [km/h] (Step S14). Similarly to the process of Step S9, the value V_target is the second threshold for determining whether the vehicle turns right or left to enter the oncoming lane for the target vehicle M.

When determination is made that the speed of the blinking vehicle is not equal to or lower than V_target [km/h], the vehicle control unit 22 proceeds to Step S18 to cause the target vehicle M to stop at the stop position P3. When the blinking vehicle is recognized in the intersecting road and the speed of the blinking vehicle is higher than V_target [km/h] that is the second threshold, the vehicle control unit 22 determines that there is a small possibility that the vehicle turns right or left to enter the oncoming lane for the target vehicle M, and causes the target vehicle M to stop at the stop position P3 set as the target stop position in the process of Step S7.

When determination is made that the speed of the blinking vehicle is equal to or lower than V_target [km/h], the vehicle control unit 22 determines whether the estimated overall length of the blinking vehicle is equal to or larger than 5 [m] (Step S15). By determining whether the estimated overall length of the blinking vehicle is equal to or larger than 5 [m] that is a fourth threshold, the vehicle control unit 22 presumes the vehicle entering the oncoming lane as either one of a small-sized vehicle and a vehicle other than the small-sized vehicle (for example, a medium-sized vehicle or a large-sized vehicle). Although the fourth threshold is 5 [m], any value other than 5 [m] may be used as long as determination can be made that the blinking vehicle is a small-sized vehicle.

When determination is made that the estimated overall length of the blinking vehicle is not equal to or larger than 5 [m], the vehicle control unit 22 proceeds to Step S18 to cause the target vehicle M to stop at the stop position P3. When the estimated overall length of the vehicle determined as entering the oncoming lane is smaller than 5 [m], the vehicle control unit 22 determines that there is a strong possibility that the vehicle entering the oncoming lane is a small-sized vehicle, and causes the target vehicle M to stop at the stop position P3 set as the target stop position in the process of Step S7.

When determination is made that the estimated overall length of the blinking vehicle is equal to or larger than 5 [m], the vehicle control unit 22 determines whether the estimated overall length of the blinking vehicle is equal to or larger than 8 [m] (Step S16). By determining whether the estimated overall length of the blinking vehicle is equal to or larger than 8 [m], the vehicle control unit 22 presumes the vehicle entering the oncoming lane as either one of a large-sized vehicle and a vehicle other than the large-sized vehicle (for example, a small-sized vehicle or a medium-sized vehicle).

When determination is made that the estimated overall length of the blinking vehicle is not equal to or larger than 8 [m], the vehicle control unit 22 proceeds to Step S12 to cause the target vehicle M to stop at the stop position P2. When the estimated overall length of the vehicle determined as entering the oncoming lane is equal to or larger than 5 [m] and smaller than 8 [m], the vehicle control unit 22 determines that there is a strong possibility that the vehicle entering the oncoming lane is a medium-sized vehicle, and causes the target vehicle M to stop at the stop position P2 farther away from the stop line L than the stop position P3 set as the target stop position in the process of Step S7.

When determination is made that the estimated overall length of the blinking vehicle is equal to or larger than 8 [m], the vehicle control unit 22 causes the target vehicle M to stop at the stop position P1 (Step S17). When the estimated overall length of the blinking vehicle is equal to or larger than 8 [m], the vehicle control unit 22 determines that there is a strong possibility that the vehicle entering the oncoming lane is a large-sized vehicle, and causes the target vehicle M to stop at the stop position P1 farther away from the stop line L than the stop position P3 set as the target stop position in the process of Step S7 and the stop position P2 set in the process of Step S16.

As described above, the vehicle control system 1 makes determination about the situation of the intersection, determines whether a vehicle is expected to enter the oncoming lane, and makes determination about the size of the vehicle when the vehicle is expected to enter the oncoming lane, thereby setting the stop position to any one of the stop line L and the stop positions P1, P2, and P3. For example, in a case where a large-sized vehicle does not turn right or left to enter the oncoming lane for the target vehicle M, the vehicle control system 1 does not cause the target vehicle M to stop at the stop position P1 distant from the stop line L. Thus, the driver does not have discomfort. According to the vehicle control system 1 of this embodiment, the stop position can appropriately be set when the target vehicle M is approaching an intersection.

Regarding the steps in the flowchart described herein, the order of execution may be changed, a plurality of steps may be executed simultaneously, or the order may be varied for each execution as long as there is no contradiction to the properties.

The embodiment of the disclosure is not limited to the embodiment described above, and various modifications and revisions may be made without departing from the gist of the disclosure.

The vehicle control unit 22 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle control unit 22 including the vehicle control calculator 22a, the intersection situation determiner 22b, the vehicle estimator 22c, and the stop position setter 22d. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle control system comprising:
a vehicle estimator configured to make determination on whether an entering vehicle entering an oncoming lane from an intersecting road is present, and estimate an overall length of the entering vehicle upon determining that the entering vehicle is present, the intersecting road intersecting a traveling road where a vehicle to which the vehicle control system is applied is traveling; and
a stop position setter configured to set a stop position of the vehicle based on the determination made by the vehicle estimator as to whether the entering vehicle is present and the estimated overall length of the entering vehicle.

2. The vehicle control system according to claim 1, further comprising an intersection situation determiner configured to determine whether a distance from a stop line to the intersecting road is equal to or larger than a first threshold, the stop line being provided at an intersection where the traveling road and the intersecting road intersect each other,
wherein the stop position setter is configured to set the vehicle to stop at the stop line in a case where the intersection situation determiner determines that the distance from the stop line to the intersecting road is equal to or larger than the first threshold.

3. The vehicle control system according to claim 2,
wherein the intersection situation determiner is configured to make determination about a type of the intersecting road, and
wherein the stop position setter is configured to set a target stop position where the vehicle is to stop based on the determination made by the intersection situation determiner about the type of the intersecting road.

4. The vehicle control system according to claim 2, wherein the vehicle estimator is configured to determine whether the entering vehicle is present based on whether a turn signal of the entering vehicle is blinking and based on a speed of the entering vehicle at the intersection.

5. The vehicle control system according to claim 3, wherein the vehicle estimator is configured to determine whether the entering vehicle is present based on whether a turn signal of the entering vehicle is blinking and based on a speed of the entering vehicle at the intersection.

6. The vehicle control system according to claim 4, wherein the vehicle estimator is configured to, in the case where determination is made that the entering vehicle is present, estimate the overall length of the entering vehicle based on an amount of projection of the entering vehicle into the intersection.

7. The vehicle control system according to claim 5, wherein the vehicle estimator is configured to, in the case where determination is made that the entering vehicle is present, estimate the overall length of the entering vehicle based on an amount of projection of the entering vehicle into the intersection.

8. A vehicle control system comprising circuitry configured to
make determination on whether an entering vehicle entering an oncoming lane from an intersecting road is present, and estimate an overall length of the entering vehicle upon determining that the entering vehicle is present, the intersecting road intersecting a traveling road where a vehicle to which the vehicle control system is applied is traveling, and
set a stop position of the vehicle based on the determination as to whether the entering vehicle is present and the estimated overall length of the entering vehicle.
